(19) United States
(12) Patent Application Publication
(10) Pub. No.: US 2023/0397041 A1
(43) Pub. Date: Dec. 7, 2023

(54) IMPROVEMENTS IN AND RELATING TO MANAGING DELAY IN A MULTI-HOP TELECOMMUNICATION NETWORK

(71) Applicant: Samsung Electronics Co., Ltd., Suwon-si, Gyeonggi-do (KR)

(72) Inventor: Milos TESANOVIC, Staines (GB)

(21) Appl. No.: 18/249,223

(22) PCT Filed: Oct. 15, 2021
(86) PCT No.: PCT/KR2021/014335

§ 371 Date: Apr. 14, 2023

(30) Foreign Application Priority Data
Oct. 15, 2020 (GB) 2016380.4

(51) Int. Cl. H04W 28/02; H04L 45/302; H04L 47/724

(52) U.S. Cl. CPC H04W 28/0268; H04W 28/0284; H04L 45/302; H04L 47/724

(57) ABSTRACT

A method of operating a multi-hop network comprises the steps of: receiving, at a second node, packet, comprising data or control signalling; calculating, at the second node, a Quality of Service, QoS, characteristic; determining, at the second node, if a Quality of Service, QoS, profile which comprises the characteristic can be guaranteed and, if the result of determining is positive, the second node determines a path and modifies the packet, if necessary, and submits a resultant packet to a next hop in the network according to the determined path; and if the result of determining is negative, the second node notifies a first node that the QoS profile cannot be guaranteed.

### CROSS-REFERENCE TO RELATED APPLICATIONS

This application is a 371 National Stage of International Application No. PCT/KR2021/014335, filed Oct. 15, 2021, which claims priority to United Kingdom Patent Application No. 2016380.4, filed Oct. 15, 2020, the disclosures of which are herein incorporated by reference in their entirety.

### BACKGROUND

### 1. Field

The present disclosure relates to multi-hop networks and, in particular, the management of delays incurred as a result of the multiple hops which necessarily make up a signal path in such networks. Embodiments of the disclosure focus on Fifth Generation (5G) telecommunication networks in particular, but other types of multi-hop networks can benefit from embodiments of the disclosure. A particular focus of embodiments of the disclosure is Integrated Access and Backhaul (IAB) networks.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

FIG. 1 shows a two-hop IAB network as known in the prior art. In a multi-hop network, the delays are likely to accumulate due to number of hops (with each hop incurring not just the propagation delay but also processing delay and half-duplex operation delay) and also aggregated volume of data at IAB nodes (leading to queueing delay). Embodiments of the present disclosure aim to address issues with such delays and so reduce the delay significantly for both the Downlink (DL) and the Uplink (UL).

5G Quality of Service (QoS) Identifier, or 5QI, is a scalar that is used to denote a specific QoS forwarding behaviour (e.g. packet loss rate, packet delay budget, guaranteed bit rate (GBR)) to be provided to a 5G QoS Flow. Standardized 5QI values have one-to-one mapping to a standardized combination of 5G QoS characteristics. How the Radio Access Network (RAN) implements this is not standardised and is left to particular implementations. However, radio standards offer a signalling design which supports decisions that the access node may take such as use of specific scheduling weights, admission thresholds, link layer protocol configuration, etc.

Packet Delay Budget (PDB) is an integral part of 5G QoS characteristics that a 5QI value represents. PDB defines an upper bound for the time that a packet may be delayed between the User Equipment (UE) and the User Plane Function (UPF) that terminates the N6 interface in the network. For a certain 5QI, the value of the PDB is the same in UL and DL. In the case of 3GPP access, the PDB is used to support the configuration of scheduling and link layer functions (e.g. the setting of scheduling priority weights and Hybrid Automatic Repeat Request (HARD) target operating points). For GBR QoS Flows using the Delay-critical resource type, a packet delayed more than PDB is counted as lost if the data burst is not exceeding the Maximum Data Burst Volume (MDBV) within the period of PDB and the QoS Flow is not exceeding the Guaranteed Flow Bit Rate (GFBR).

The 5G Access Network Packet Delay Budget (5G-AN PDB) is determined by subtracting a static value for the Core Network Packet Delay Budget (CN PDB), which represents the delay between any UPF terminating N6 (that may possibly be selected for the PDU Session) from a given PDB.

### SUMMARY

Embodiments of the disclosure aim to provide means to ensure that QoS and, in particular, the PDB components of QoS is met across multi-hop networks.

According to a first aspect of the disclosure, there is provided a method of operating a multi-hop network comprising the steps of: receiving, at a second node, packet, comprising data or control signalling; calculating, at the second node, a Quality of Service, QoS, characteristic; determining, at the second node, if a Quality of Service, QoS, profile which comprises the characteristic can be guaranteed and, if the result of determining is positive, the second node determines a path and modifies the packet, if necessary, and submits a resultant packet to a next hop in the network according to the determined path; and if the result of determining is negative, the second node notifies a first node that the QoS profile cannot be guaranteed.

In an embodiment, the network is an Integrated Access and Backhaul, IAB, network.

In an embodiment, the packet is a Backhaul Adaptation Protocol, BAP, packet.

In an embodiment, the QoS characteristic is one of: PDB, required/expected/intended Packet Error-Rate, PER, and guaranteed bit-rate.

In an embodiment, the step of determining comprises one or more of: estimated processing time at each node; a switching delay between Rx and Tx functions of a node; and the UL/DL frame switching delay.

In an embodiment, the first node takes into account the QoS characteristic for a given QoS flow when mapping the QoS flow to one or more bearers and then routing accordingly.

In an embodiment, when routing, one or more of the following steps are implemented: using fewer hops; routes with fewer or no congestion reports; setting priorities between paths; and assigning new parent node(s).

In an embodiment, the first node sets scheduling priority weights and HARQ target operating points to be used by the one or more second nodes, based on QoS estimates for multi-hop operation.

In an embodiment, feedback from one or more second nodes on locally-made routing decisions, projected failed delivery or handover, is signalled to and taken into account by the first node.

In an embodiment, the QoS characteristic is shared with the one or more second nodes.

In an embodiment, a BAP header includes a bearer ID of an associated bearer.

According to a second aspect of the disclosure, there is provided method of operating a multi-hop network comprising the steps of: receiving at a first node a Quality of Service indicator, 5QI, from a core network; calculating a Quality of Service, QoS, characteristic; receiving at the first node, assistance information from one or more second nodes; determining at the first node if a QoS profile which comprises the QoS characteristic can be guaranteed and if the result of determining is positive, the first node configures link-layer functions of the one or more second nodes and/or compiles routing tables; and if the result of determining is negative, the first node notifies the core network that the QoS profile cannot be guaranteed.

In an embodiment, the network is an Integrated Access and Backhaul, IAB, network.

In an embodiment, the QoS characteristic is one of: PDB required/expected/intended Packet Error-Rate, PER, and guaranteed bit-rate.

In an embodiment, the step of determining comprises one or more of: estimated processing time at each node; a switching delay between Rx and Tx functions of a node; and the UL/DL frame switching delay.

In an embodiment, the first node takes into account the QoS characteristic for a given QoS flow when mapping the QoS flow to one or more bearers and then routing accordingly.

In an embodiment, one or more of the following steps are implemented: using fewer hops; routes with fewer or no congestion reports; setting priorities; and assigning new parent node(s).

In an embodiment, the first node sets scheduling priority weights and HARQ target operating points to be used by the one or more second nodes, based on QoS estimates for multi-hop operation.

In an embodiment, feedback from one or more second nodes on locally-made routing decisions, projected failed delivery or handover, is signalled to and taken into account by the first node.

In an embodiment, the QoS characteristic is shared with the one or more second nodes.

According to a third aspect of the disclosure, there is provided a method comprising the method of the first aspect and the second aspect

According to a fourth aspect of the disclosure, there is provided network operable to perform the method of any of the previous aspects.

According to an aspect of the present disclosure, intermediate nodes in a multi-hop network are arranged to make decisions in relation to incoming packets. In an embodiment, they are able to divert or drop a packet according to certain conditions. In prior art IAB networks, the decision making ability of individual nodes is generally limited to the specific case of radio link failure RLF. In such a case, a node can deviate from explicit signalling information, but this is clearly a special case.

In an embodiment, the local decision making can be limited to making a selection from a predefined list of possible options. Alternatively, greater autonomy can be granted to the local node, as required.

According to another aspect of the present disclosure, one or more feedback paths are provided whereby the CU is provided with information which assists in ensuring that PDB can be met across a multi-hop network.

Extra signalling can, of course, introduce an additional overhead on the network and can, if over-used, result in a worse performance than if it were not used. However, by striking the correct balance, the extra signalling can improve performance.

According to the present disclosure there is provided an apparatus and method as set forth in the appended claims. Other features of the disclosure will be apparent from the dependent claims, and the description which follows.

Although a few preferred embodiments of the present disclosure have been shown and described, it will be appreciated by those skilled in the art that various changes and modifications might be made without departing from the scope of the disclosure, as defined in the appended claims.

For a better understanding of the disclosure, and to show how embodiments of the same may be carried into effect, reference will now be made, by way of example only, to the accompanying diagrammatic drawings.

The present disclosure relates to a pre-5th-Generation (5G) or 5G communication system to be provided for supporting higher data rates beyond 4th-Generation (4G) communication system such as long term evolution (LTE). Embodiments of the present disclosure provide methods and systems for ensuring that QoS and, in particular, the PDB components of QoS is met across multi-hop networks.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows an IAB network according to the prior art;

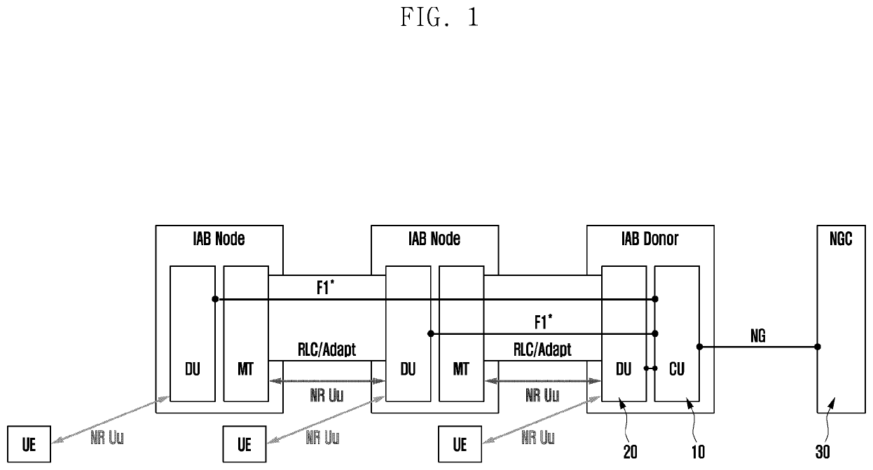

FIG. 2 show two types of control PDU, known in the prior art;

FIG. 3 shows a flowchart according to an embodiment of the disclosure; and

FIG. 4 shows a flowchart according to another embodiment of the disclosure.

Throughout the drawings, it should be noted that like reference numbers are used to depict the same or similar elements, features, and structures.

### DETAILED DESCRIPTION

In an embodiment of this disclosure, the gNB (Donor-CU) 10 sends a notification towards the Service Network Framework (SNF) that the QoS profile cannot be guaranteed, based on one or more parameters indicating the status of one or more of IAB nodes or links en-route to the potentially multiple destinations for a given QoS flow, and possibly based on one or more parameters indicating the status of the wider network. As an example, feedback from individual nodes on congestion (obtained, in part, based on flow control feedback) or Radio Link Failure (RLF) along the potential paths can be taken into account.

In a further refinement, the gNB (Donor-CU) 10 sends a notification towards SNF that QoS profile can again be guaranteed, based on one or more parameters indicating status of one or more of IAB nodes or links en-route to the destination for a given QoS flow. The estimates of whether the QoS profile (and especially the PDB aspect) can be met can, in addition, include: estimated processing time at each of the nodes; the switching delay between Rx and Tx functions of a node; and the UL/DL frame (slot) switching delay.

In another embodiment, the gNB (Donor-CU) 10 takes into account the for a given QoS flow when mapping this flow to one or more bearers and configuring routing appropriately. An example action would be using shorter routes (fewer hops), or routes where there have been no or few congestion reports, as well as setting priority of different paths for the case where there is more than one path from an intermediate node (including Donor-DU to the destination. Another example action is assigning new parent node(s) for one or more nodes (or UEs) within the network.

In another embodiment, Donor-CU 10 sets scheduling priority weights and HARQ target operating points to be used by intermediate nodes based on QoS estimates for multi-hop.

In an embodiment, local decision making by an intermediate node is permitted and in such a configuration, feedback from intermediate nodes on locally-made routing decisions (such as changes in routing from the routing prescribed by the CU 10), projected failed delivery, handover, is signalled to and taken into account by the CU 10. This additional feedback permits the CU 10 to gather information on individual performance of intermediate nodes and factor any delays into its routing decisions and instructions. It should be noted that even in cases without local decision making at the intermediate nodes, additional feedback to the CU can still assist when it makes its routing decisions and instructions,

In another embodiment linked to local decision-making, PDB is shared with the intermediate nodes (e.g. average PDB per link is shared in a configuration message, obtained by dividing the original PDB with the number of hops and shared by the CU 10; or, PDB-related information is included in the packet header and then each intermediate node modifies the PDB part of the header by deducting a certain value in response to the delay already incurred; or, some other QoS parameter is included in the Backhaul Adaptation Protocol (BAP) header). This could be part of the BAP header or introduced at a different layer.

In a refinement, the PDB or PER or guaranteed bit-rate values are modified from the original end-to-end values, for instance:
PDB is adjusted to take into account the shorter than originally envisaged distance to the destination e.g. due to rerouting and/or changes in topology;
PER is adjusted so that links with lower PER (for instance, when higher delay on a specific link can be tolerated and retransmissions are expected to occur) or higher PER can be used;
GBR is adjusted so that a more stringent rate is required from the next hop(s) due to delays already incurred.

To assist the intermediate nodes, time-stamps (e.g. validity/expiry time of a packet; recommended/expected per-hop delay etc.) are included in headers of packets, so that intermediate nodes can make the right routing and/or scheduling decisions on the basis of this time-stamp information.

In an embodiment, the information on packet validity or QoS (such as time-stamps, PDB) is used to trigger flow control feedback polling of the child node and/or flow control feedback reporting to the parent node. All the packets with the same QoS characteristic(s) may be grouped for purposes for such flow control reporting.

In the prior art, Hop by Hop flow control feedback is limited to single-hop, downlink only (meaning that the feedback is sent in uplink direction) and includes available or desired buffer size (in absolute terms, rather than relative terms e.g. percentage). Additionally, the flow control feedback can only be reported for a subset of bearers with the same routing ID (basically bearers heading to the same final destination), or for the entire channel (total buffer status of a channel of the link). Moreover, reporting based on polling and threshold-based reporting are both introduced.

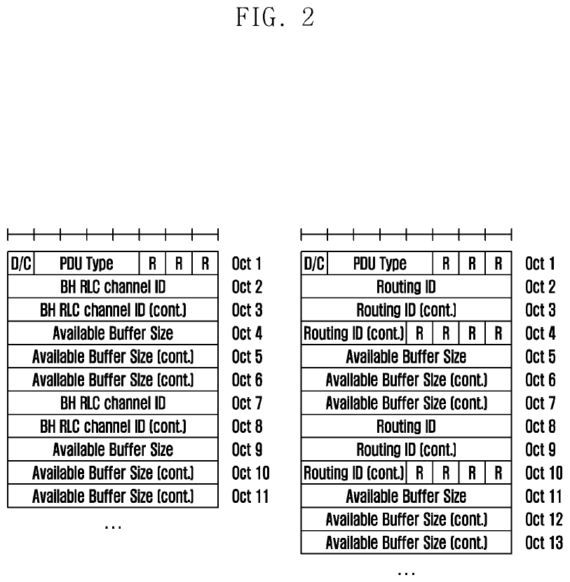

FIG. 2 illustrates control PDUs for the two types of flow control feedback (per routing ID, and per BH channel respectively) known in the prior art.

In embodiments of the present disclosure, one or more existing control PDUs (as shown, for example, in FIG. 2) may be used for reporting the enhanced content according to the embodiments described. For instance, one of the reserved ‘R’ bits may be used to indicate that what is being reported is per QoS characteristic (i.e. all packets with same or similar QoS characteristic are grouped for purposes of reporting), and the fields for BH RLC Channel ID or Routing ID may then be used to indicate said QoS characteristic. Additional fields may be added to the control PDU to carry, for instance, desired data rate for a node in question and for a given type of traffic (with certain QoS characteristics) or preferred number of hops to the node to which the report refers.

For 1:1 mapping between bearers and backhaul channels, it is not necessary to include the bearer ID in the BAP header (or elsewhere), but embodiments of the disclosure do not preclude it.

However, for N:1 mapping, in an embodiment of this disclosure the bearer ID is included. In this way, per-bearer use of adjusted QoS characteristics (e.g. PDB), is possible even for the case of N:1 mapping.

Typically, a static value for the Core Network (CN) portion of the PDB of 2 ms for the delay between a UPF terminating N6 and a 5G-Access Network should be subtracted from a given PDB to derive the packet delay budget that applies to the radio interface. It is this value that applies to the radio interface that has been referred to thus far.

In a refinement of the above mentioned embodiments, a dynamic value for the CN PDB is used to work out the 5G Access Network Packet Delay Budget (5G-AN PDB). For instance, this may be the case if, based on feedback received from UEs and intermediate nodes, the Donor-CU 10 works out that less stringent treatment on the radio network is required (or the opposite).

For relaying systems where intermediate nodes handle fully-blown QoS flows and not just BAP packets (e.g. Layer-3 relaying), in an embodiment of this disclosure the 5QI/QFI is shared with some or all of the intermediate nodes along a route. In a refinement, the mapping of the 5QI/QFI to QoS characteristics is modified, for instance:
PDB is adjusted to take into account the shorter distance to the destination;
PER is adjusted so that links with lower PER (for instance, when higher delay on a specific link can be tolerated) or higher PER can be used;
GBR is adjusted so that a more stringent rate is required from the next hop(s) due to delays already incurred.

In another refinement, intermediate nodes are given a different 5QI/QFI value (while keeping the same mapping of the 5QI/QFI to QoS characteristics).

The above description concentrates on the DL, but on the UL, similar considerations as above apply. One additional consideration is modification to admission policy, based on the best or average or e.g. 90-percentile delay that could be offered to a UE on the UL across the IAB network. The estimates could additionally take into account whether the network deploys other UL-specific delay-mitigating techniques such as pre-emptive Buffer Status Report (BSR).

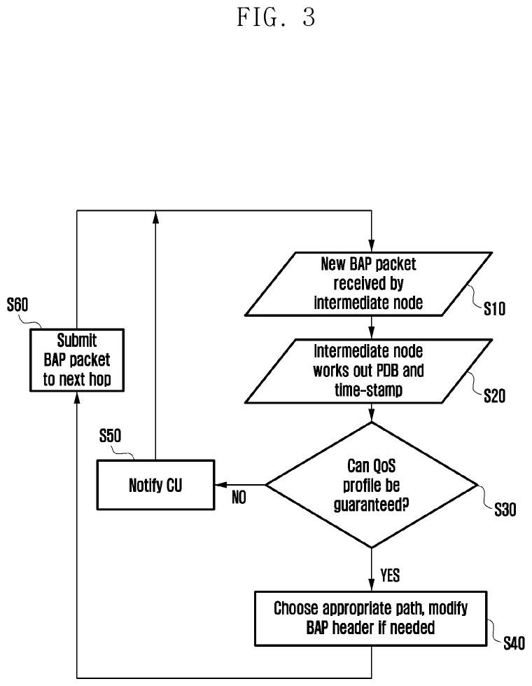

FIG. 3 is a flowchart which illustrates certain steps in a first embodiment. It relates specifically to operation whereby a BAP packet is received, determining if QoS profile can be guaranteed and actions taken in accordance with that determination. In general, FIG. 3 relates to the local decision-making referred to previously.

At S10, a new BAP packet is received by an intermediate node.

At S20, the intermediate node calculates whether the PDB can be met, based on PDB-related information in the BAP packet, or PDB-related information (e.g. PDB per link) received in a configuration message from the CU, and the time stamp included in the BAP packet.

At S30, the intermediate node determines if the QoS profile can be guaranteed.

If not, flow continues to S50, where the CU is notified that the QoS profile cannot be guaranteed and flow returns to S10 again.

If the result of the determination at S30 is that the QoS profile can be guaranteed, then at S40 an appropriate path is chosen and the BAP header is modified, if required. Step S40 represents the local decision-making process, referred to previously. Here, the intermediate node is taking independent action on the basis of the determination at step S30, which may result in a modified path. If so, the BAP header is modified accordingly so that the following node(s) are not confused.

Then, at S60, the BAP packet is submitted to the next hop and then flow returns to S10.

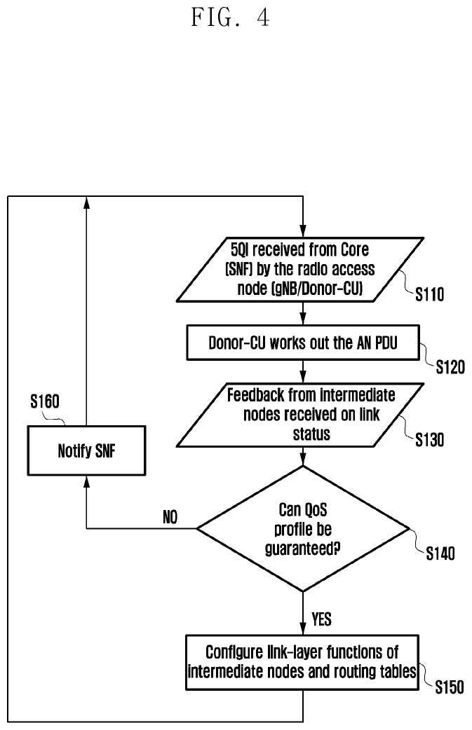

FIG. 4 is a flowchart which illustrates certain steps which are related to the CU features of embodiments of the disclosure. It should be noted that the methods shown in FIGS. 3 and 4 may be implemented together or separately. Greater improvements may be achieved in system performance if both are used, but neither relies upon the other.

At S110, 5QI is received from the SNF in the CN 30 at the gNB/Donor CU 10.

At S120, the CU 10 calculates the AN PDB

At S130, the CU 10 receives feedback from the intermediate node(s) related to the respective link status(es).

At S140, the CU 10 determines if the QoS profile can be guaranteed. If not, at S160, the SNF is notified and flow returns to S110.

If the determination at S140 reveals that the QoS profile can be guaranteed, then at S150, the CU configures link-layer functions of the intermediate node(s) and compiles the necessary routing tables. Flow then returns to S110.

By use of embodiments of the present disclosure, improvements in the performance of an IAB network may be obtained. Such improvements are realised by either or both of increased signalling of assistance information, primarily from intermediate nodes to the donor CU, and an increased level of local decision making at the intermediate nodes.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1-15. (canceled)

16. A method performed by a first node operating in a multi-hop network, the method comprising:
receiving, from a second node, a packet;
determining whether a quality of service, QoS, profile is guaranteed;
in case that the QoS profile is guaranteed, determining a path for transmitting the packet, and
transmitting, to a third node, the packet based on the determined path.

17. The method of claim 16, wherein the multi-hop network is an Integrated Access and Backhaul, IAB, network, and
wherein the packet is a Backhaul Adaptation Protocol, BAP, packet.

18. The method of claim 16, wherein the QoS profile comprises a QoS characteristic that is one of a Packet Delay Budget, PDB, required/expected/intended Packet Error-Rate, PER, or a guaranteed bit-rate.

19. The method of claim 16, wherein the determining whether the QoS profile is guaranteed comprises estimating one or more of a processing time at each node, a switching delay between reception, Rx, and transmission, Tx, functions of the node, and a uplink, UL, /downlink, DL, frame switching delay.

20. The method of claim 16, further comprising:
modifying a header of the packet,
wherein the transmitting of the packet comprises transmitting, to the third node, the packet with the modified header based on the determined path.

21. The method of claim 16, further comprising:
transmitting, to the second node, feedback information associated with the determination of the path.

22. The method of claim 16, further comprising:
in case that the QoS profile is not guaranteed, transmitting, to the second node, information indicating that the QoS profile is not guaranteed.

23. The method of claim 16,
wherein a header of the packet received from the second node includes time information including an expiry time of the packet and a delay per a hop.

24. The method of claim 17, wherein a header of the BAP packet includes a bearer identifier, ID, of an associated bearer.

25. The method of claim 17,
wherein the second node is a parent node of the first node and the third node is a child node of the first node.

26. A first node operating in a multi-hop network, the first node comprising:
one or more processor configured to:
receive, from a second node, a packet,
determine whether a quality of service, QoS, profile is guaranteed,
in case that the QoS profile is guaranteed, determine a path for transmitting the packet, and
transmit, to a third node, the packet based on the determined path.

27. The first node of claim 26, wherein the multi-hop network is an Integrated Access and Backhaul, IAB, network, and
wherein the packet is a Backhaul Adaptation Protocol, BAP, packet.

28. The first node of claim 26, wherein the one or more processor is further configured to:
modify a header of the packet, and
transmitting, to the third node, the packet with the modified header based on the determined path.

29. The first node of claim 26, wherein the one or more processor is further configured to:
in case that the QoS profile is not guaranteed, transmit, to the second node, information indicating that the QoS profile is not guaranteed.

30. The first node of claim 26, wherein the one or more processor is further configured to:
transmit, to the second node, feedback information associated with the determination of the path.
